(19) United States
(12) Patent Application Publication
(10) Pub. No.: US 2017/0318755 A1
(43) Pub. Date: Nov. 9, 2017

(54) COLLAPSIBLE SUPPORT STRUCTURE AND METHOD OF USING THE SAME

(71) Applicant: Bryan Ladd, West Des Moines, IA (US)

(72) Inventor: Bryan Ladd, West Des Moines, IA (US)

(21) Appl. No.: 15/148,750

(22) Filed: May 6, 2016

(51) Int. Cl. A01G 9/12; A01G 17/14; A01G 1/00

(52) U.S. Cl. CPC A01G 9/122; A01G 1/001; A01G 17/14

(57) ABSTRACT

The present invention relates to a collapsible support structure and its method of use. The support structure has a vertical support with a water inlet and tip with one or more holes. The vertical support in one arrangement is separable into a first and second portion that is connected by inserting the first portion into a receiving end of the second portion. Connection members connect horizontal supports to the vertical support. The horizontal supports extend perpendicularly outward from the vertical body due their friction fit connection, which allows for their unaided extension. The method of use includes attaching a water source to the water inlet to pressurize water within the vertical support that projects water from the tip. In turn, the vertical support is easily inserted into the ground, where it is left in place until the ground dries to the vertical support providing additional rigidity and support.

### BACKGROUND OF THE INVENTION

This invention is directed towards a support structure for planting. More specifically, and without limitation, this invention relates to a collapsible support structure and method of using the same.

Support structures are well known in the art and have been used by gardeners for generations in order to improve the yield obtained from their gardens. Support structures allow a gardener to elevate their vegetation, such as tomatoes, cucumbers, and the like, off of the garden bed, which in turns allows the vegetation to grow more abundantly as the vegetation is not growing upon itself and is better exposed to the nutrients necessary for life, including water and sunlight. Additionally, elevation increases the vegetation's sanitation and reduces its exposure to pests, such as rabbits, rats, insects, and other microorganisms that threaten to cause harm. Even simpler, raising vegetation prevents a gardener from accidentally stepping on their crop. Support structures are also useful to increase the exploitation of a garden plot. For instance, in urban regions the amount of area available to an individual to cultivate a garden is limited. As such, individuals must grow their gardens upwards instead of outwards.

The most conventional support structure is a garden stake that is a single wooden or metal post that is inserted into the ground. This traditional approach has a number of deficiencies. For one, a garden stake requires blunt force to be inserted into the ground or in the alternative, the application of substantial weight or force. The application of such a force on the stake can result in damage to the stake. Oftentimes, the individual using the stake is not capable of applying the requisite amount of force to the stake and the stake is not inserted into the ground a sufficient distance even if a hammer or other tool is used, which results in the stake failing when the vegetation growing on the stake becomes too heavy or a strong wind blows against the stake causing the stake to tip or completely fall over, thereby damaging the vegetation.

Conventional stakes are further deficient in the difficulties presented in their removal. More particularly, conventional stakes, even when not sufficiently inserted into the ground, become mired in the dirt due to repeated drying and watering, which causes the ground around the stake to close in around the stake more closely and to adhere to the stake. When an individual goes to remove the stake, there is typically nothing to provide a sufficient grip and the stake is difficult, if not impossible, to remove from the ground. As a result, stakes are often damaged or broken or even left in place instead of being removed.

The difficulties presented with traditional stakes are intensified when used to hold up larger vegetation, such as a tree or sapling that needs additional support, especially during its early stages of growth. This is due to a need for multiple stakes, as a single stake lacks the sufficient strength and rigidity to support a sapling or tree. In turn, an individual must insert and subsequently remove multiple stakes that may still fail if the stakes are not sufficiently inserted into the ground given the strength or weight of the tree or sapling, or due to inclement weather.

Yet another deficiency associated with conventional garden stakes is the need to tie vegetation to the stake using string or wire. This is a tedious task, especially with quick-growing or multi-branch vegetation that may require a high level of attention to ensure that the vegetation does not pull free from the stake. Also, the use of string or wire runs the risk of risk of damaging the vegetation as the string or wire can sever the stem or other portions of the vegetation.

One advancement that has taken place to overcome the deficiencies of traditional garden stakes are tomato cages, which are easier to insert and remove and do not require the use of cordage, such as wire and string. Tomato cages have three or more legs or posts that extend upwardly and outwardly to form a conical shape. Connecting the posts are one or more horizontal supports. The tomato cage is inserted into the ground over the vegetation and as the vegetation grows, the horizontal supports provide structural support to the vegetation and areas to lay the stems and branches over.

This solution, however, has its deficiencies. Namely, tomato cages are still difficult to insert into the ground. Posts of a tomato cage are made of small diameter wire or plastic that bends or breaks when encountering hard soil. Further, given their small diameter, the posts do not provide a sufficient surface area for the soil to adhere and harden to in order to hold the tomato cage securely into the ground. As a result, tomato cages are subject to fall over during severe weather or when the vegetation being supported becomes top heavy.

Additionally, because tomato cages are made of wire, they are not well suited for handling large loads of vegetation. For instance, consumer tomato cages tend to fail when vegetation becomes top heavy as some plants can produce a crop of thirty pounds or more. Similarly, the wiry construction of tomato cage makes them highly susceptible to damage caused by weather, use, and accidents.

Further, given their enclosed structure, tomato cages are not suitable for supporting trees and saplings. In particular, once the tree or sapling has grown to a sufficient size where the tree or sapling can safely support itself without deforming, a tomato cage cannot be removed without being destroyed as the tree or sapling is often too large or has too much foliage to remove the cage.

Another problem associated with tomato cages is their large footprint during nonuse. More pointedly, when the growing season has ended and a tomato cage is removed from the ground for storage, its bulky design takes up a significant amount of space in a person's garage or storage shed. This is particularly troublesome in urban environments where storage space may be limited.

U.S. Pat. No. 7,774,977 to Miller Shelton discloses a plant support that includes three legs and two horizontal supports. The plant support is constructed and deconstructed by engaging the legs with horizontal rings of the support and terminating the lower end of each leg in the ground or dirt for stability. In this way, the plant support can be separated for condensed storage.

U.S. Pat. No. 6,453,606 to Shulman et al. discloses a collapsible plant support that includes three or more vertical members connected to multiple rings that function as guide hubs for vertical members, which are connected via connection members. The plant support is assembled by spreading the vertical members equidistant from one another about the rings and then inserting the plant support into the ground. When not in use, the vertical members are positioned next to one another and the rings are folded over, such that the vertical members and rings are in substantially parallel alignment, thereby providing a limited footprint for storage.

Despite these advances and others, problems still remain. In particular, these advances are difficult and time consuming to assemble. Additionally, these advancements still require numerous legs or posts in order to support vegetation as they are structurally weak and risk tipping and breakage. Still further, these advancements are difficult to insert and remove from the ground as they still require application of weight or force to install and remove, which presents the problem of incorrect installation.

Thus it is a primary objective of this invention to provide a collapsible support structure that improves upon the art.

Another objective of this invention is to provide a support structure that facilitates insertion into and removal from the ground.

Yet another objective of this invention is to provide a support structure that is quick and simple to install.

Another objective of this invention is to provide a support structure that has a limited number of parts and is structurally sound.

Yet another objective of this invention is to provide a support structure that is user friendly.

Another objective of this invention is to provide a support structure that takes up a limited amount of space during storage.

Yet another objective of this invention is to provide a support structure that resists tipping and breakage.

These and other objectives, features, and advantages of the invention will become apparent from the specification and claims.

### BRIEF DESCRIPTION OF THE DRAWINGS

FIG. 1 is a front view of a collapsible support structure;

FIG. 2 is a side view of a collapsible support structure;

FIG. 2A is a close up side view of connection member of a collapsible support structure;

FIG. 2B is a close up side view of connection member of a collapsible support structure;

FIG. 3 is a front view of a collapsible support structure;

FIG. 4 is a front view of a collapsible support structure; and

FIG. 5 is a side view of a collapsible support structure.

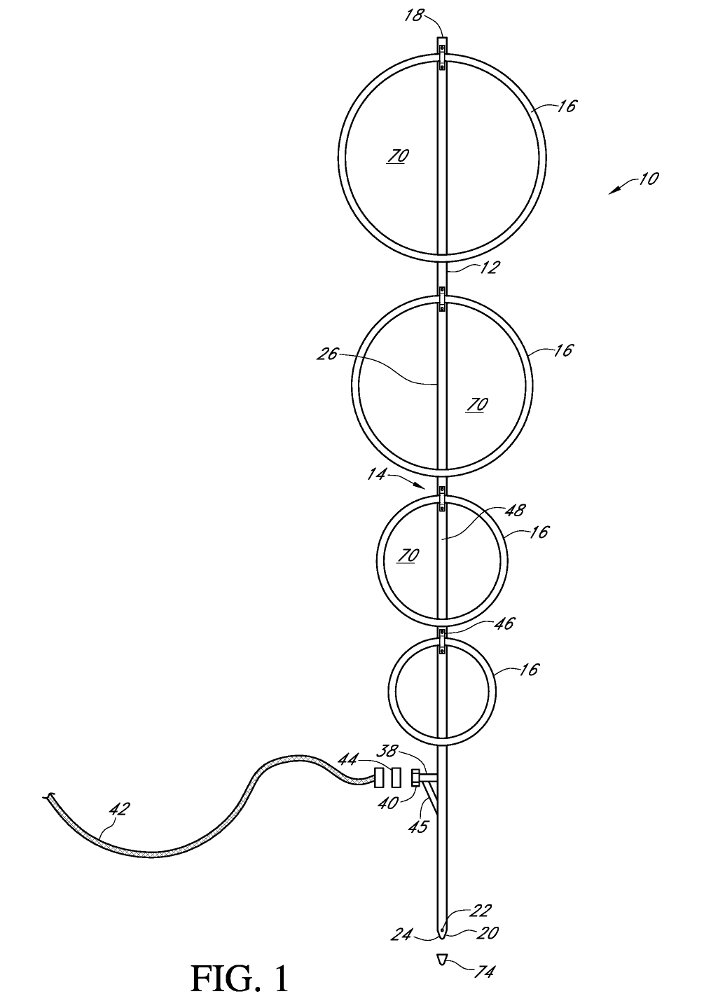

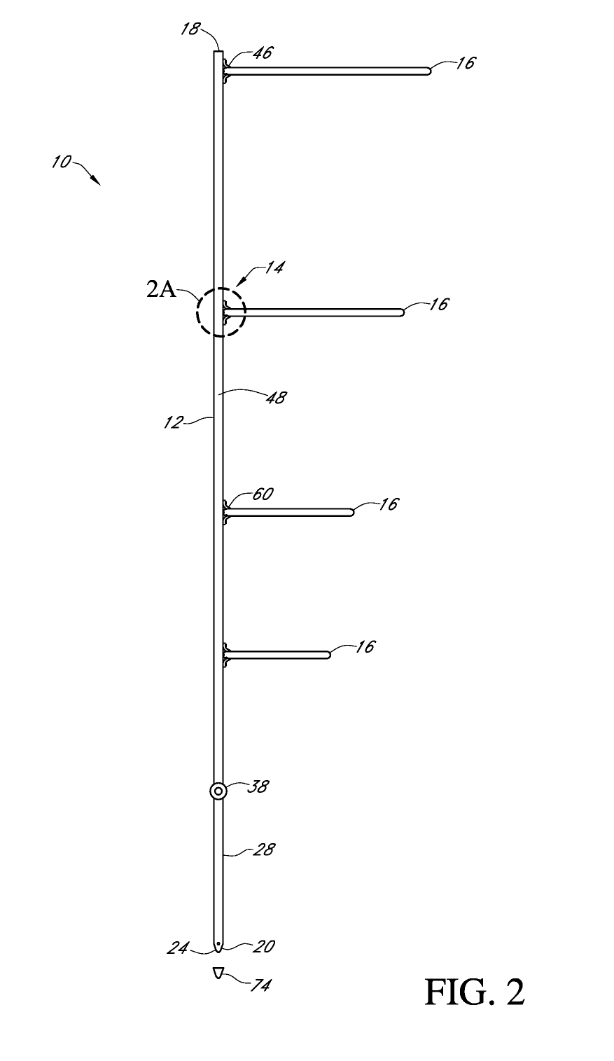

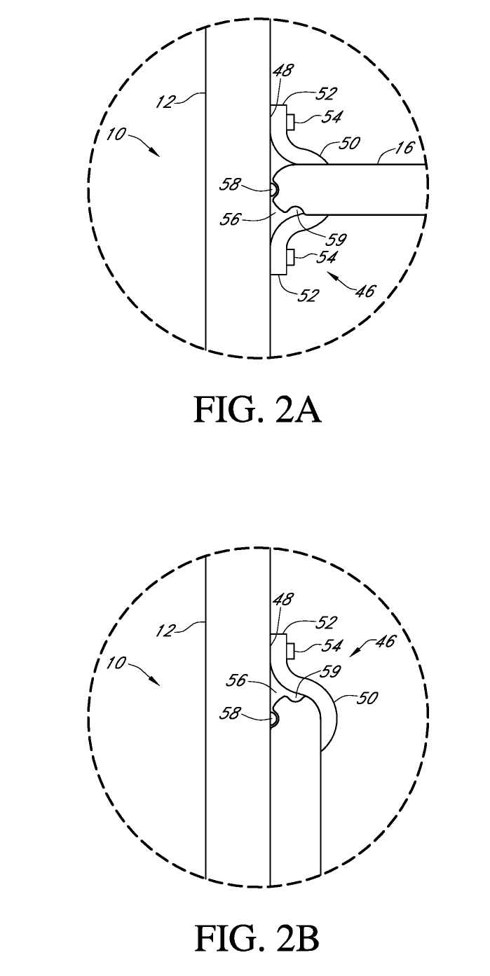

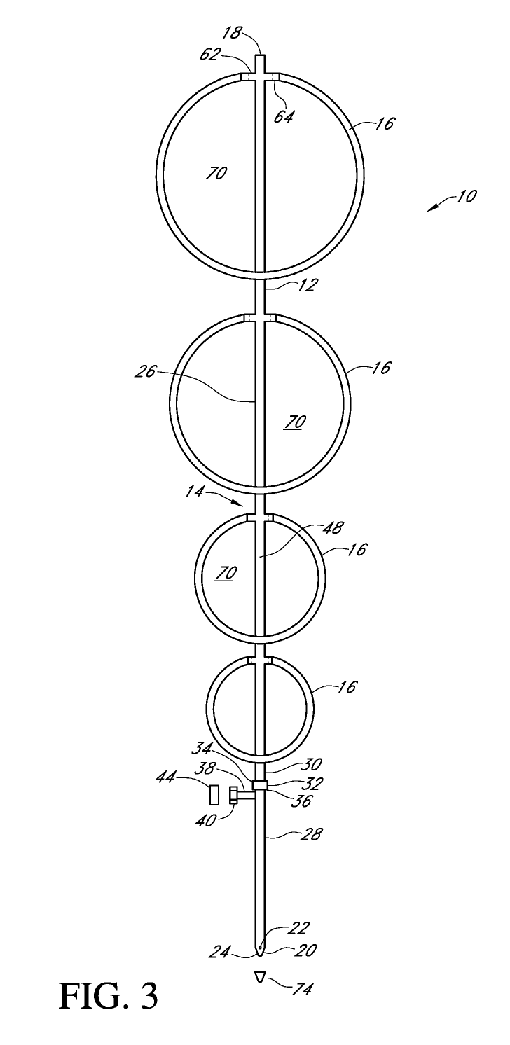

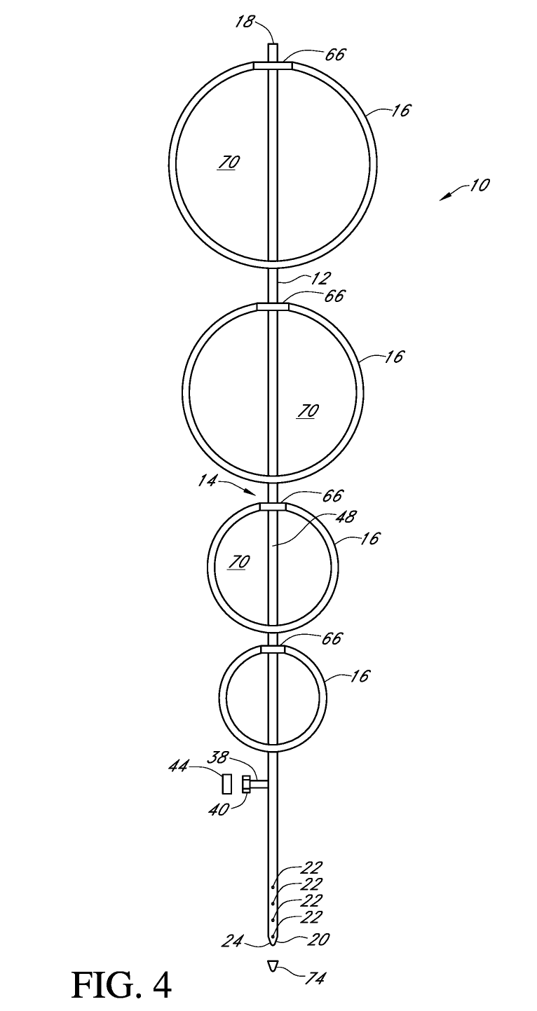

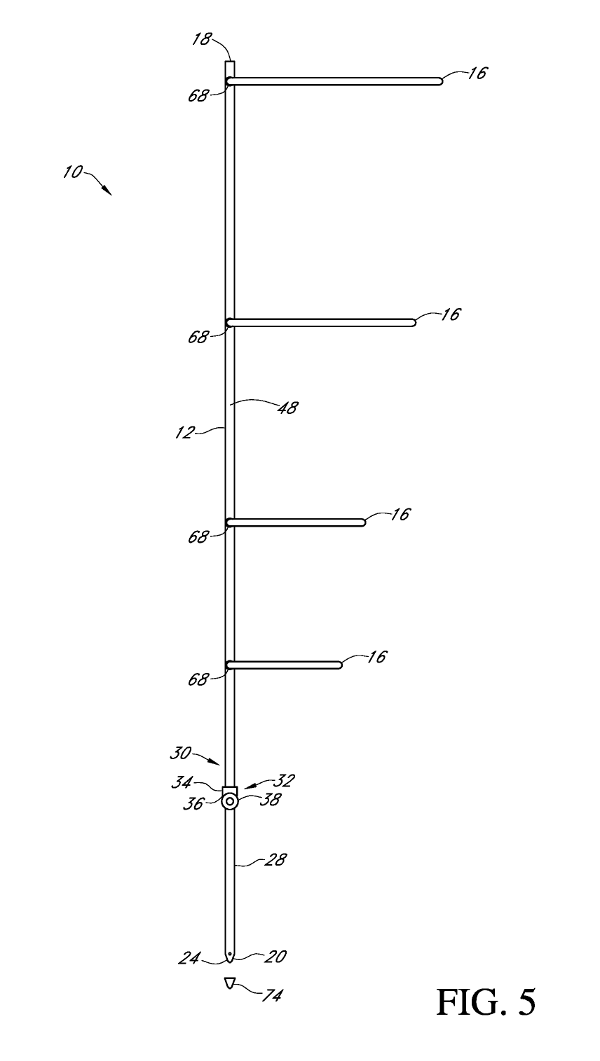

### SUMMARY OF THE INVENTION

In general, the present invention relates to a collapsible support structure and the method of using the same. The support structure has a vertical support with a water inlet and tip with one or more holes positioned on its conical surface. The vertical support in one arrangement is separable into a first and second portion that is connected by inserting the first portion into a receiving end of the second portion. This allows for condensed storage as well as the added benefit of easier installation as only the second portion of the invention needs to be used for installation into the ground, as the rest of the invention can be installed or constructed after the second portion is in place.

Connection members connect horizontal supports to the vertical support. The horizontal supports extend perpendicularly outward from the vertical body due to their friction fit connection, which allows for their unaided extension. The type of connection member can vary. For instance, a clip, a cuff, or a bracket can be included with the vertical member for connecting the horizontal support to the vertical member. Alternatively, apertures can be extended through the vertical support and the horizontal members can be received through the apertures.

The method of use includes attaching a water source to the water inlet to pressurize water within the vertical support that projects water from the tip. In turn, the vertical support is easily inserted into the ground, where it is left in place until the ground dries to the vertical support providing additional rigidity and support. Upon removal, water is again projected from the holes to saturate and soften the ground and the vertical support is removed with ease. To store, the horizontal members are folded over into a collapsed position where they extend in substantially parallel alignment with the vertical support to take up a minimal amount of space.

### DETAILED DESCRIPTION

With reference to the figures, a collapsible support structure 10 is shown having a single vertical support 12, one or more connection members 14, and one or more horizontal supports 16.

The vertical support 12 in one embodiment is a cylindrical hollow body, but can be entirely solid, or partially hollow and partially solid and can be rectangular, triangular, or any other suitable shape. The vertical support 12 in one illustrative embodiment is made of copper and is ¾″ in diameter. Although larger and smaller diameters are contemplated, ¾″ diameter provides sufficient rigidity without becoming too heavy. Further, smaller diameters, such as ½″, have been found to be wobbly if the vertical support 12 is entirely hollow. In other arrangements the vertical support 12 is made of other materials such as wood, plastic, or other suitable outdoor materials.

The vertical support 12 extends from a top end 18 to a tip 20. In one illustrative arrangement, the vertical support 12 has a length of 5.5′, but can be of any suitable length. The tip 20 angled at 45° in one arrangement and approximately 45° in other arrangements, and still other angles in other embodiments. The tip 20 is rounded, such that the tip 20 does not form a sharp point in order to prevent severing a utility line, which could result in harm to a user of the support structure 10 or property.

The tip 20 has one or more holes 22 positioned on a conical surface 24 of the tip 20. The holes 22 are not positioned centrally on the tip 20 as that can result in the holes 22 becoming obstructed during insertion of the support structure 10. The holes 22 in one arrangement have a diameter between 1/16″ and ⅛″ in order to reduce the likelihood that debris will obstruct the holes 22. Additionally, smaller diameter holes 22 increase the pressure of water projecting from the holes 22 during insertion. In other arrangements, however, larger and smaller holes 22 are contemplated.

In one arrangement, the vertical support 12 has a first portion 26 and a second portion 28 that are separable. In this arrangement, the first portion 26 extends from the top end to a bottom end 30 and the second portion 28 extends from a receiving end 32 to the tip 20. The receiving end 32 is sized and shaped to receive the bottom end 30 of the first portion 18. In one illustrative embodiment, the receiving end 32 has a cylindrical wall 34 connected to a circular base 36 that forms an opening 38 to receive the bottom end 30. In other embodiments, the cylindrical wall 34 and the circular base can be of any suitable shape and size to receive the bottom end 30.

In this arrangement, the first portion 26 need not be made of the same material as the second portion 28. For instance, in one arrangement the first portion 26 is made of wood and the second portion 28 is made of metal. Additionally, the first portion 26 in one arrangement is solid whereas the second portion 28 is hollow. In one illustrative embodiment, the first portion 26 has a length of 4′ and the second portion 28 has a length of 1.5′. In other arrangements, the second portion 28 includes additional holes 22 positioned on its exterior surface in addition to the holes 22 on the tip 20 in order to increase the amount of water projected from the support structure 10.

In fluid communication with the tip 20 is a water inlet 38. In one arrangement, the water inlet 38 is connected adjacent the tip 20. In another arrangement, the water inlet 38 is incorporated into the top end 18 or the receiving end 32. In one illustrative embodiment, the water inlet 38 is connected just below to the receiving end 32 and perpendicular to the second portion 28. In such an embodiment, the water inlet 38 is positioned such that the second portion receiving end 32 and water inlet 38 are the only visible components of the second portion 28 when the second portion 28 is inserted into the ground. In other arrangements, the water inlet 38 is positioned anywhere along the vertical support 12 that permits water to pressurize within the vertical support 12 and to project from the holes 22 in the tip 20.

The water inlet 38 has a threaded portion 40 for receiving a water source or garden hose 42. The threaded portion 38 also receives a cap 44 when the water source 42 is not attached in order to prevent debris from collecting in the water inlet 38.

In one embodiment of the invention, a reinforcement member 45 is connected to the water inlet 38 at one end and the support structure at the other end, such that the water inlet 38 is reinforced. In one particular arrangement, the reinforcement member 45 is connected at a downwardly extending angle between the water inlet 38 and the second portion 28. In the embodiment, the water inlet 38 is positioned perpendicularly or substantially perpendicularly to the vertical support 12. As the water inlet 38 is reinforced, the water inlet 38 can be used as a foot peg, lever point, or connection point without concern for breakage and would also serve to keep the support structure 10 from twisting or turning in the ground once installed.

The one or more connection members 14 connect the one or more horizontal supports 16 to the vertical support 12. In one arrangement, the connection members 14 are one or more clips 46 connected to exterior surface 48 of the vertical support 12. The clips 46 in one embodiment have a raised rounded portion 50 that extends away from the vertical support 12 that terminates in a pair of flanges 52 at each end. The flanges 52 receive connectors or screws 54 to connect the clips 46 to the vertical support 12. In other embodiments, the clips 46 are attached in any other suitable manner.

The raised portion 50 of each clip 46 forms an opening 56 to receive one horizontal support 16 with a friction fit. For instance, in one exemplary embodiment, the opening 56 and the horizontal support 16 both have a diameter of ⅜″. In this manner, the horizontal support 16 is manually rotatable from a collapsed position and an unaided extended position, wherein the horizontal support 16 extends outwardly generally perpendicular from the vertical support 12 without the assistance of additional tools or connection devices other than the connection member 14 and the position is maintained without assistance. The use of friction fit resists gravity and the free rotation of horizontal supports 16 in a horizontal or vertical direction. Also, the use of friction fitting and unaided extension allows for the unexpected benefit of easy assembly and elimination of parts outside of the connection to the vertical support 12.

In other embodiments, the clips 46 or vertical support 12 have a notch 58 that is received within a recess 59 the horizontal support 16 to provide additional support. In alternative arrangement, the horizontal support 16 has the notch 58 that is received in the recess 59 of the clip 46 or vertical support 12. In one arrangement, the clips 46 include a gasket or O-ring 60 is positioned within the opening 56 to improve the friction fit further. Alternatively, the gasket 60 is a thumb screw 60 that secures the horizontal support 16 to the vertical support 12.

In an alternative embodiment, the one or more connection members 14 are cuffs 62 that extend perpendicularly outward from the vertical support 12. The cuffs 62 in one arrangement are welded or connected in any conventional manner to the exterior surface 48 of the vertical support 12. In an alternative arrangement, the cuffs 62 are part of a uniform body that is cast or molded. The cuffs 62 are sized and shaped to receive the horizontal supports 16 in a friction fit manner such that the horizontal supports 16 can transition from the collapsed position to the unaided extended position. In one embodiment, the cuffs 62 have an extended portion 64 that extends a predetermined length of the horizontal supports 16 thereby engaging more of the horizontal support 16 providing greater friction fit and support. In some arrangements, O-rings 60 are positioned within the cuffs 62.

When cuffs 62 are used as connection members 14, the horizontal supports 16 are not continuous. Instead, the horizontal supports 16 terminate in order to be received within the respective cuff 62. In some arrangements, the horizontal supports 16 are sized and shaped to be received in the extended portions 64 of the cuffs 62.

In another embodiment, the connection members 14 are one or more brackets 66 connected to the exterior surface 48 of the vertical support 12 to transition between a collapsed and unaided extended position. In one arrangement, the brackets 66 are welded to the vertical support 12, but in other arrangements are connected in any suitable manner, such as molded or screwing. In this embodiment, each bracket 66 has a pair of cuffs 64. In one arrangement, the cuffs 64 are positioned in alignment with the vertical support 12, such that one end of each cuff 64 terminates against the vertical support 12.

In another arrangement, the cuffs 64 of the brackets 66 are out of alignment with the vertical support 12. In this arrangement, the cuffs 64 are positioned such that the horizontal support 16 can pass through the cuffs 64 without encountering the vertical support 12. In an alternative of this arrangement, a single cuff 64 is used that is centrally located with the vertical support 12 much like a door knocker. The inclusion of the gasket, O-ring, or thumb screw 60 in the connection member 14 is also contemplated in these arrangements to.

In yet another embodiment, the vertical support 12 does not have connection members 14. Instead, one or more apertures 68 extend through the vertical support 12 and the horizontal support 16 is received through the aperture 68 with a friction fit. In this embodiment, the apertures 68 are sized and shaped to receive the horizontal supports 16 closely enough to allow transition between the collapsed position and the unaided extended position.

The number of horizontal supports 16 can vary and the horizontal supports 16 be of any shape and size, such as rectangular, triangular, or round. In one illustrative embodiment, the support structure 10 has four horizontal supports 16 that have central openings 70 for vegetation 72 (not shown) to pass through, with diameters of 14″, 12″, 10″, and 7″ in descending order. In another arrangement, the support structure 10 only has three horizontal supports 16.

The horizontal supports 16 can be made of any suitable materials, such as wood, metal, or plastic. In one exemplary embodiment, the horizontal supports 16 are made of copper and are hollow. The use of hollow materials cuts down on the weight of the horizontal supports 16 and further assists in maintaining the unaided extended position. The diameter of the horizontal supports 16 in one embodiment is ⅜″, but other sizes are contemplated. The use of smaller diameters can result in damage to vegetation 72, whereas larger diameters can become too heavy.

In operation, an individual plants vegetation 72, such as tomatoes, cucumbers, a tree, or a sapling in the ground. Then the individual attaches the water source 42 to the water inlet 38. In one arrangement, the water inlet 38 is connected only to the second portion 28 of the vertical support 12 to reduce the difficulty of assembly. Once the water source 42 is attached, the water source 42 is activated. Water is pressurized within the vertical support 12 and pressurized water projects out the holes 22 in the tip 20 of the vertical support 12.

The individual places the tip 20 in the ground near the vegetation 72 or alternatively, where the vegetation will be planted as the support structure 10 can be installed before planting. The pressurized water saturates the ground outwardly, which in turn significantly softens the ground. The individual inserts the vertical support 12 into the ground with minimal to no effort to the desired depth. The use of blunt force will not be necessary given the saturated ground. Once the vertical support 12 is at the desired depth, the individual can remove the vertical support 12 if desired and place a cover 74 over the tip 20 to prevent debris or sediment from entering the tip 20. In one arrangement, the cover 74 is affixed to the tip 20, such that water pressure disengages the cover 74 from the surface of the tip 20 sufficiently during insertion, but when the water source 42 is deactivated the cover reengages the tip 20, thereby covering the holes 22 to prevent debris or sediment from entering the tip 20.

Otherwise, the individual deactivates and removes the water source 42 from the water inlet 38. The cap 44 is then placed over the water inlet 38. If the individual is using a vertical support 12 that has a first portion 26 and a second portion 28, the first portion is inserted into the receiving end 32 of the second portion 28.

Next, the horizontal members 16 are transitioned from the collapsed position to the unaided extended position. In some arrangements with connection members 14 that are clips 46 or brackets 66, the connection members 14 are connected to the exterior surface 48 of the vertical support 12 such that the vertical support 12 passes through the opening in the horizontal members 16. In this arrangement, when the horizontal members 16 are in a collapsed position, the horizontal members 16 rest with one side of each horizontal member 16 engaging the opposite side of the vertical member 12. In this same arrangement, the horizontal members 16 are provided with additional support from the vertical member 12 as the horizontal members 16 extend outwardly with the vertical member 12 extending upwardly through the opening 70 while engaging the horizontal members 16. This in turn reduces the stress on the screws 54 when clips 46 are used and the welds when brackets 66 are used as connection members 14.

Over time, the ground dries around the vertical support 12, including the tip 20 and the second portion 28, to provide superior rigidity to the support structure 10 not previously seen in the prior art, which further resists tipping and breakage. Further, as the vegetation 72 grows up through the horizontal supports 16 it provides additional support to the horizontal supports to maintain their perpendicular or generally perpendicular outward extension.

At the end of the season, or when the individual desires to remove the support structure 10, the individual first transitions the horizontal supports 16 from the unaided extended position to the collapsed position. The individual may also remove the first portion 26. Then the individual removes the cap 44 and again attaches the water source 42 to the water inlet. The water is then activated and after a predetermined amount of time, the individual removes the vertical support 12 from the ground with minimal to no effort. The use of exertion should not be necessary. The vertical support 12 is then stored with the horizontal members 16 in the collapsed position, wherein the horizontal supports extend in substantially parallel spaced alignment with the vertical support.

In an alternative embodiment of the invention, the individual inserts the second portion 28 into the ground as detailed. The individual then connects a structure 76 (not shown) to either the receiving end 32 or the water inlet 38. For instance, in one embodiment, the structure 76 is a mailbox post that is received within the receiving end. In another embodiment, the structure 76 is a fence and the user inserts a plurality of vertical supports 12 in the ground and connects the fencing there between. In other embodiments the structure 76 is decorative fencing, pot hangers, trellises, birdhouse or birdfeeder hangers, rabbit fencing, tree stakes, or landscape edging, or other lawn and garden implements and décor. In still other embodiments the structure 76 is of any kind that requires stabilization or partial or whole insertion within the ground.

Therefore, a collapsible 10 has been provided that is quick and simple to install, has a limited number of parts and is structurally sound, is user friendly, facilitates insertion and removal from the ground, takes up a limited amount of space during storage, resists tipping and breakage, and improves upon the art.

From the above discussion and accompanying figures and claims, it will be appreciated that the collapsible support structure 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A collapsible support structure comprising:
a vertical support having a water inlet and a tip with one or more holes; and
one or more horizontal supports connected to the vertical support by one or more connection members.

2. The collapsible support structure of claim 1 further comprising the vertical support structure having a first portion and a second portion, wherein the first portion is received in a receiving end of the second portion.

3. The collapsible support structure of claim 1 wherein the one or more connection members are configured to receive the one or more horizontal supports with a friction fit, such that the horizontal supports manually transition from a collapsed position to an unaided extended position.

4. The collapsible support structure of claim 1 wherein the one or more horizontal supports are connected to only one vertical support.

5. The collapsible support structure of claim 1 wherein the holes are positioned on a conical surface of the tip.

6. A method of using a collapsible support structure, comprising:
providing a vertical support having a water inlet and a tip with one or more holes;
attaching a water source to the water inlet;
pressurizing water within the vertical support;
projecting pressurized water from the one or more holes;
inserting the vertical support into the ground;
removing the water source from the water inlet; and
allowing the ground to dry and adhere to the vertical support.

7. The method of claim 6 further comprising the step of transitioning a horizontal support connected to the vertical support from a collapsed position to an unaided extended position.
